(19) United States
(12) Patent Application Publication
(10) Pub. No.: US 2026/0183977 A1
(43) Pub. Date: Jul. 2, 2026

(54) SHAVING TOOL BIT ADOPTING PENETRATING-TYPE FIXING STRUCTURE

(71) Applicant: Ziyi DONG, Zhongshan (CN)

(72) Inventors: Ziyi DONG, Zhongshan (CN); Hua XIAO, Zhongshan (CN)

(21) Appl. No.: 19/007,442

(22) Filed: Dec. 31, 2024

(51) Int. Cl. B26B 19/06; B26B 19/38

(52) U.S. Cl. CPC B26B 19/06; B26B 19/386

(57) ABSTRACT

1. A shaving tool bit adopting a penetrating-type fixing structure comprises a bottom shell, a fixed blade and a movable blade, a movable blade support is arranged in the bottom shell, a fixing pressing plate is arranged above the fixed blade, limiting columns penetrating through the fixed blade and the movable blade and extending towards the bottom shell are arranged at two ends of a bottom face of the fixing pressing plate, the fixed blade is provided with a through hole for the limiting column to penetrate through, limiting bayonets used for clamping the limiting columns to provide a reciprocating motion space for the movable blade are arranged at two ends of the movable blade, and a plurality of protection teeth with tail ends exceeding an outer edge of the movable blade are arranged on two sides of the bottom shell and located below the movable blade.

### TECHNICAL FIELD

The present invention relates to the technical field of shavers, in particular to a shaving tool bit adopting a penetrating-type fixing structure.

### BACKGROUND OF THE PRESENT INVENTION

Existing reciprocating shaving tool bit structures are all composed of a fixed blade, a movable blade, a fixing frame and a bottom shell, and a fixing and assembly structure of the shaving tool bits mostly adopts an internal lock and a fastener in combination with a screw, a screw hole and welding for fixing, so that the assembly structure is complicated and the assembly process is cumbersome, and parts are difficult to be disassembled and replaced. When the shaving tool bits are used for a too long time, the movable blade is no longer sharp and the shaving effect becomes worse, the whole tool bit can only be scrapped and replaced, which is easy to cause waste of resources.

Moreover, according to the existing reciprocating shaving tool bit structures, the fixed blade is outside and the movable blade is inside, one face of movable blade teeth is attached to the fixed blade, and the other face of the movable blade teeth is often exposed. When a shaver is used and held in a forward direction, the fixed blade in the shaving tool bit is attached to the skin, so that there is no need to worry that the movable blade teeth will scratch the skin. However, during shaving, because it is inconvenient to keep the holding direction of the shaver for some shaving parts, the exposed face of the movable blade teeth is very easy to accidentally scratch the skin.

In order to solve the above defects, the present invention provides a shaving tool bit adopting a penetrating-type fixing structure.

### SUMMARY OF THE PRESENT INVENTION

In order to facilitate assembly or disassembly of a shaving tool bit and replacement of a movable blade, and improve the safety of the shaving tool bit at the same time, the present invention provides a shaving tool bit adopting a penetrating-type fixing structure.

In order to solve the above problem, the following technical solution is provided by the present invention.

A shaving tool bit adopting a penetrating-type fixing structure, comprising a bottom shell, a fixed blade and a movable blade, wherein a movable blade support for mounting the movable blade is arranged in the bottom shell in a reciprocating mode, a fixing pressing plate is arranged above the fixed blade, limiting columns penetrating through the fixed blade and the movable blade and extending towards the bottom shell are arranged at two ends of a bottom face of the fixing pressing plate, the fixed blade is provided with a through hole for the limiting column to penetrate through, limiting bayonets used for clamping the limiting columns to provide a reciprocating motion space for the movable blade are arranged at two ends of the movable blade, and a plurality of protection teeth with tail ends exceeding an outer edge of the movable blade are arranged on two sides of the bottom shell and located below the movable blade.

According to the shaving tool bit adopting the penetrating-type fixing structure above, two sides of the fixed blade and the movable blade are respectively provided with a plurality of fixed blade teeth and movable blade teeth extending outwards, top faces of the movable blade teeth are attached to bottom faces of the fixed blade teeth, and a gap is left between the protection teeth and the movable blade teeth.

According to the shaving tool bit adopting the penetrating-type fixing structure above, outer edges of the protection teeth outwardly exceed outer edges of the movable blade teeth and do not exceed outermost ends of the fixed blade teeth, a number and a layout of the protection teeth correspond to those of the fixed blade teeth, and protection heads having a smooth surface and bent towards the movable blade are arranged at tail ends of the fixed blade teeth.

According to the shaving tool bit adopting the penetrating-type fixing structure above, a screw hole is arranged in the limiting column, and a screw penetrating through the bottom shell and screwed into the screw hole is arranged below the bottom shell.

According to the shaving tool bit adopting the penetrating-type fixing structure above, positioning mounting columns extending towards the fixed blade are arranged at two ends of a top face of the movable blade support, a positioning mounting hole for nesting the positioning mounting column is correspondingly arranged in the movable blade, and a limiting sliding groove corresponding to the positioning mounting column is arranged on the fixed blade.

According to the shaving tool bit adopting the penetrating-type fixing structure above, an elastic sheet for abutting against a bottom face of the movable blade support to attach the movable blade teeth to the fixed blade teeth is arranged in the bottom shell, and the bottom face of the movable blade support is provided with a reciprocating baffle for cooperating with a main body of a shaver to drive the movable blade support to reciprocate.

According to the shaving tool bit adopting the penetrating-type fixing structure above, end covers are arranged at two ends of the bottom shell, the end cover is provided with a cleaning port communicated with an inner cavity of the bottom shell, and a connecting frame for connecting the main body of the shaver is arranged below the bottom shell.

According to the shaving tool bit adopting the penetrating-type fixing structure above, two ends of the connecting frame are rotatably hinged on outer walls of the end covers, and the outer wall of the end cover is provided with a torsion spring for resetting an inclination angle of the shaving tool bit.

According to the shaving tool bit adopting the penetrating-type fixing structure above, the fixing pressing plate and the limiting column are an integrated part formed integrally by injection molding, and a face cover for enhancing skin feeling is attached to an upper surface of the fixing pressing plate.

According to the shaving tool bit adopting the penetrating-type fixing structure above, a height from an upper surface of the fixed blade to a bottom face of the bottom shell is not more than 5 mm.

Compared with the prior art, the present invention has the following advantages.

1. The shaving tool bit adopting the penetrating-type fixing structure of the present invention is provided with the fixing pressing plate and the limiting columns penetrating through the fixed blade and the movable blade and extending towards the bottom shell, and meanwhile, the fixed blade and the movable blade are respectively provided with the through hole for the limiting column to penetrate through and the limiting bayonet; when the shaving tool bit is assembled, only the movable blade support, the movable blade, the fixed blade and the fixing pressing plate need to be sequentially stacked and mounted in an interior or at an upper end of the bottom shell, and meanwhile, the limiting columns sequentially penetrate through the through holes and the limiting bayonets at the same time, and then the screws are screwed into the screw holes from a bottom end of the bottom shell; similarly, when the shaving tool bit is disassembled, the screws only need to be screwed out, so that the shaving tool bit is very convenient to assemble or disassemble; and when the shaving tool bit is used for a too long time, the movable blade is no longer sharp and the shaving effect becomes worse, the movable blade can be replaced independently, the replacement process is very convenient, and the whole tool bit does not need to be scrapped, so that the service life of the shaving tool bit is prolonged, the blade can be recycled conveniently, and production resources are saved.

2. The shaving tool bit adopting the penetrating-type fixing structure of the present invention is provided with the protection teeth, the outer edge of the protection teeth outwardly exceeds the outer edge of the movable blade teeth, and the movable blade teeth are completely hidden between the fixed blade teeth and the protection teeth, so that upper and lower faces of the movable blade teeth are both protected; when the shaver is used for shaving, there is no need to worry that the movable blade teeth will scratch the skin regardless of whether the shaver is held in a forward or reverse direction, thus greatly improving the safety of the shaving tool bit in use, and meanwhile, the gap is left between the protection teeth and the movable blade teeth, which can prevent the shaving effect of the shaving tool bit from being influenced and prevent the hair from being caught, and improve the experience during shaving; and the number and the layout of the protection teeth correspond to those of the fixed blade teeth, and the protection teeth correspond to the fixed blade teeth one by one, which can effectively guide the hair to enter the fixed blade teeth to be cut, so as to improve the shaving efficiency, and the corresponding layouts of the protection teeth and the fixed blade teeth make the appearance of the shaving tool bit more exquisite.

3. According to the shaving tool bit adopting the penetrating-type fixing structure of the present invention, the protection heads are arranged at the tail ends of the fixed blade teeth, the protection head has the smooth surface and is bent towards the movable blade, so that the shaving tool bit can be moved on the skin more smoothly, the skin feeling of the shaving tool bit can be enhanced, and the fixed blade teeth can be prevented from scratching the skin at the same time, thus improving the use experience of the shaving tool bit.

4. According to the shaving tool bit adopting the penetrating-type fixing structure of the present invention, the elastic sheet structure is adopted to replace a common spring structure to attach the movable blade teeth to the fixed blade teeth, so that an overall thickness of the shaving tool bit can be thinner, and meanwhile, because the shaving tool bit adopts the penetrating-type fixing structure, the bottom shell and the movable blade support in the bottom shell may be smaller, and the overall thickness of the shaving tool bit can be reduced, so that a total thickness of the shaving tool bit does not exceed 5 mm, thus making the appearance of the shaving tool bit more exquisite.

### DESCRIPTION OF THE DRAWINGS

FIG. 1 is a stereoscopic diagram of a shaving tool bit;

FIG. 2 is a bottom view of the shaving tool bit;

FIG. 3 is an enlarged view of a region D in FIG. 2;

FIG. 4 is a first exploded view of the shaving tool bit;

FIG. 5 is a second exploded view of the shaving tool bit;

FIG. 6 is a third exploded view of the shaving tool bit;

FIG. 7 is a fourth exploded view of the shaving tool bit; and

FIG. 8 is a schematic diagram of another embodiment of a connecting frame.

In the drawings, 1 refers to bottom shell; 2 refers to fixed blade; 3 refers to movable blade; 4 refers to movable blade support; 5 refers to fixed blade tooth; 6 refers to movable blade tooth; 7 refers to protection tooth; 8 refers to protection head; 9 refers to fixing pressing plate; 10 refers to limiting column; 11 refers to through hole; 12 refers to limiting bayonet; 13 refers to screw hole; 14 refers to screw; 15 refers to elastic sheet; 16 refers to positioning mounting column; 17 refers to positioning mounting hole; 18 refers to limiting sliding groove; 19 refers to reciprocating baffle; 20 refers to connecting frame; 21 refers to end cover; 22 refers to cleaning port; 23 refers to torsion spring; and 24 refers to face cover.

### DETAILED DESCRIPTION OF PREFERRED EMBODIMENTS

The technical features of the present invention will be further described in detail hereinafter with reference to the drawings to facilitate understanding by those skilled in the art. The up, down, left and right orientations described herein are consistent with those as shown in the drawings.

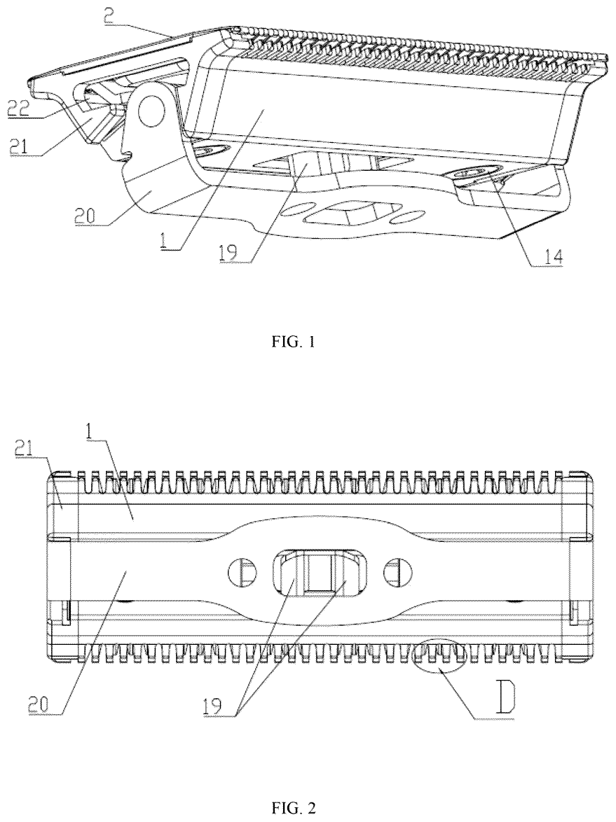

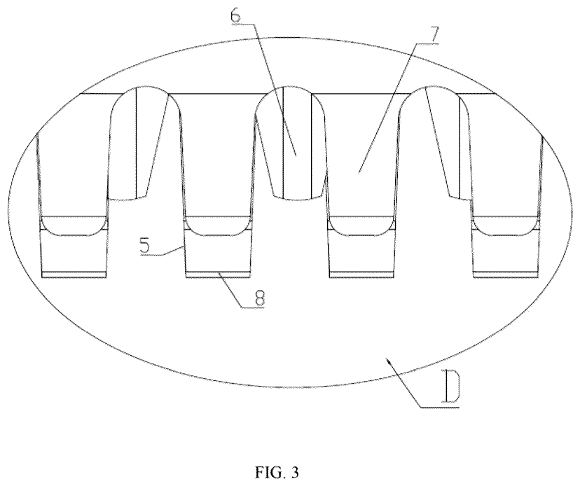

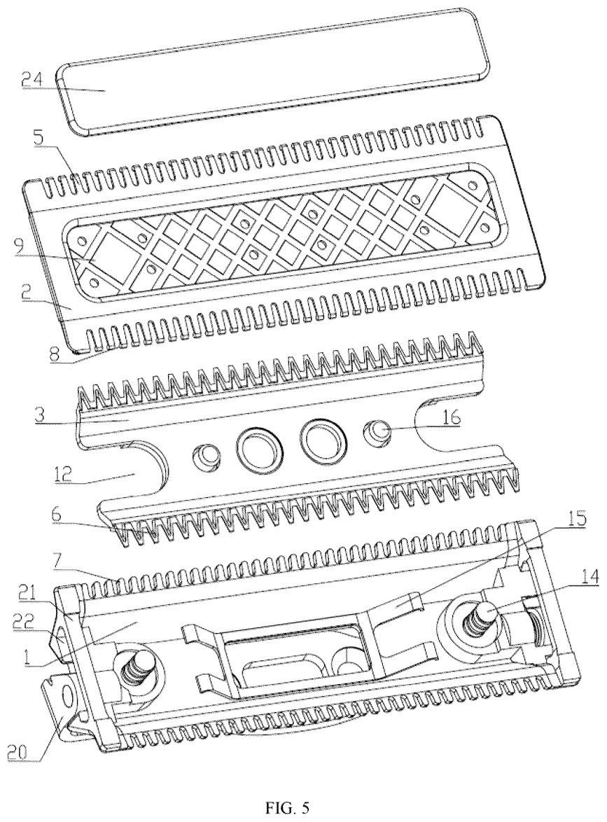

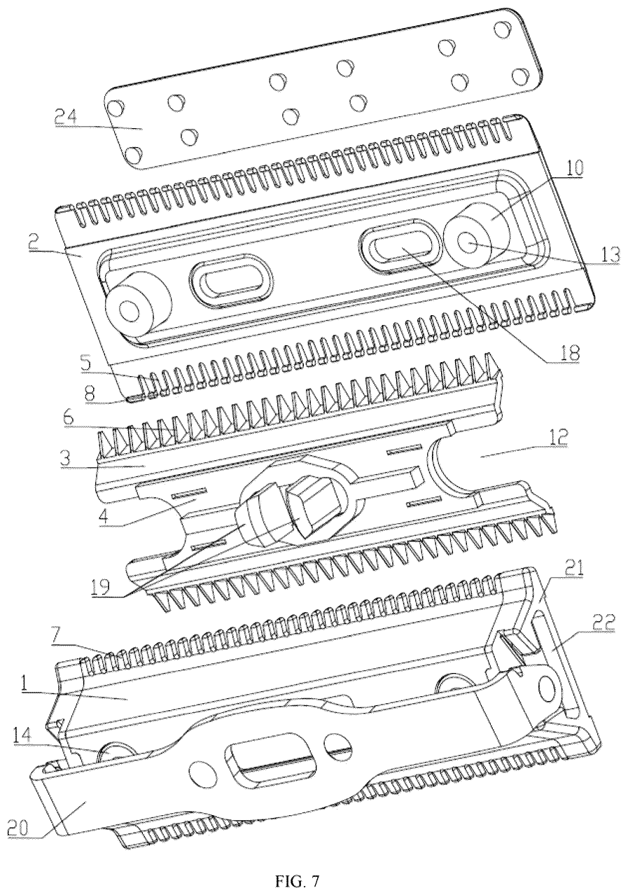

A shaving tool bit adopting a penetrating-type fixing structure, as shown in FIG. 1 to FIG. 8, comprises a bottom shell 1, a fixed blade 2 and a movable blade 3, wherein a movable blade support 4 for mounting the movable blade 3 is arranged in the bottom shell 1 in a reciprocating mode, a fixing pressing plate 9 is arranged above the fixed blade 2, limiting columns 10 penetrating through the fixed blade 2 and the movable blade 3 and extending towards the bottom shell 1 are arranged at two ends of a bottom face of the fixing pressing plate 9, the fixed blade 2 is provided with a through hole 11 for the limiting column 10 to penetrate through, limiting bayonets 12 used for clamping the limiting columns 10 to provide a reciprocating motion space for the movable blade 3 are arranged at two ends of the movable blade 3, and the limiting bayonets 12 can also cooperate with the limiting columns 10 to prevent the movable blade 3 from deviating or swinging without affecting a reciprocating motion of the movable blade 3. When the shaving tool bit is assembled, only the movable blade support 4, the movable blade 3, the fixed blade 2 and the fixing pressing plate 9 need to be sequentially stacked and mounted in an interior or at an upper end of the bottom shell 1, and then the fixing pressing plate 9 and the bottom shell 1 are connected and fixed by a screw or a fastener, so that the shaving tool bit is very convenient to assemble or disassemble; and when the shaving tool bit is used for a too long time, the movable blade is no longer sharp and the shaving effect becomes worse, the movable blade 3 can be replaced independently, the replacement process is very convenient, and the whole tool bit does not need to be scrapped, so that the service life of the shaving tool bit is prolonged, the blade can be recycled conveniently, and production resources are saved. A plurality of protection teeth 7 with tail ends exceeding an outer edge of the movable blade 3 are arranged on two sides of the bottom shell 1 and located below the movable blade 3, a shape of the tail ends of the protection teeth 7 is generally designed as a smooth curved face or a tangent face without sharp edges and corners, which prevents the skin from being pricked during shaving to affect the use experience. The movable blade teeth 6 are completely hidden between the fixed blade teeth 5 and the protection teeth 7, so that upper and lower faces of the movable blade teeth 6 are both protected. When the shaver is used for shaving, there is no need to worry that the movable blade teeth 6 will scratch the skin regardless of whether the shaver is held in a forward or reverse direction, thus greatly improving the safety of the shaving tool bit in use.

Specifically, two sides of the fixed blade 2 and the movable blade 3 are respectively provided with a plurality of fixed blade teeth 5 and movable blade teeth 6 extending outwards, top faces of the movable blade teeth 6 are attached to bottom faces of the fixed blade teeth 5, and a gap is left between the protection teeth 7 and the movable blade teeth 6, which can prevent the shaving effect of the shaving tool bit from being influenced and prevent the hair from being caught, and improve the experience during shaving.

In addition, outer edges of the protection teeth 7 outwardly exceed outer edges of the movable blade teeth 6 and do not exceed outermost ends of the fixed blade teeth 5. If the protection teeth 7 are too short, the movable blade teeth 6 cannot be completely covered, so that the protection effect is poor, and if the protection teeth 7 are too long, the attachment of the fixed blade teeth 5 to the skin may be influenced, which easily leads to incomplete hair shaving, thus affecting the shaving effect. A number and a layout of the protection teeth 7 correspond to those of the fixed blade teeth 5, and the protection teeth 7 correspond to the fixed blade teeth 5 one by one, which can effectively guide the hair to enter the fixed blade teeth 5 to facilitate cutting by the movable blade teeth 6, so as to improve the shaving efficiency, and the corresponding layouts of the protection teeth 7 and the fixed blade teeth 5 make the appearance of the shaving tool bit more exquisite. Protection heads 8 having a smooth surface and bent towards the movable blade 3 are arranged at tail ends of the fixed blade teeth 5, so that the protection heads 8 can make the shaving tool bit move on the skin more smoothly, the skin feeling of the shaving tool bit can be enhanced, and the fixed blade teeth 5 can be prevented from scratching the skin at the same time, thus improving the use experience of the shaving tool bit.

Moreover, both of the fixed blade 2 and the movable blade 3 in the shaving tool bit structure can be processed and produced by a stamping process, which is more efficient in production and processing than an etching process, and meanwhile, middle portions of the fixed blade 2 and the movable blade 3 are both provided with a U-shaped groove formed by stamping. Compared with a flat blade, the blade with the U-shaped groove has higher strength, is not easy to deform in a process of processing and transportation, and is easier to maintain a higher flatness of the blade teeth, so as to indirectly improve the shaving sharpness of the shaving tool bit, and also facilitate the attachment and mounting of the fixed blade 2 and the movable blade 3.

Specifically, a screw hole 13 is arranged in the limiting column 10, and a screw 14 penetrating through the bottom shell 1 and screwed into the screw hole 13 is arranged below the bottom shell 1. When the shaving tool bit is assembled, only the movable blade support 4, the movable blade 3, the fixed blade 2 and the fixing pressing plate 9 need to be sequentially stacked and mounted in an interior or at an upper end of the bottom shell 1, the limiting columns 10 sequentially penetrate through the through holes 11 and the limiting bayonets 12 at the same time, and then the screws 14 are screwed into the screw holes 13 from a bottom end of the bottom shell 1 to complete the assembly. When the shaving tool bit is disassembled, the screws 14 only need to be screwed out, so that the assembly and disassembly processes are simple and quick. According to the shaving tool bit, the fixing pressing plate 9 may also be assembled and fixed in the bottom shell 1 by fastening, only a clamping elastic sheet needs to be arranged at a bottom end of the limiting column 10, and the bottom shell 1 is provided with a clamping hole corresponding to the clamping elastic sheet, so that the clamping elastic sheet directly penetrates through the clamping hole to fasten the bottom face of the bottom shell 1 to complete the assembly and fixing of the shaving tool bit, and only the clamping elastic sheet needs to be pushed out of the clamping hole when disassembling, so that the assembly and disassembly processes are equally convenient.

In addition, positioning mounting columns 16 extending towards the fixed blade 2 are arranged at two ends of a top face of the movable blade support 4, a positioning mounting hole 17 for nesting the positioning mounting column 16 is correspondingly arranged in the movable blade 3, and a limiting sliding groove 18 corresponding to the positioning mounting column 16 is arranged on the fixed blade 2. The limiting sliding groove 18 is a waist-shaped hole, which can further limit mounting positions of the movable blade 3 and the movable blade support 4 without affecting the reciprocating motion of the movable blade 3, thus preventing the movable blade 3 and the movable blade support 4 from deviating or swinging during the reciprocating motion.

Specifically, an elastic sheet 15 for abutting against a bottom face of the movable blade support 4 to attach the movable blade teeth 6 to the fixed blade teeth 5 is arranged in the bottom shell 1, and a spring in a conventional tool bit structure is replaced with the elastic sheet 15, so that an overall thickness of the shaving tool bit is thinner. The bottom face of the movable blade support 4 is provided with a reciprocating baffle 19, the reciprocating baffle 19 is used for cooperating with an eccentric shaft on a main body of a shaver to drive the movable blade support 4 and the movable blade 3 to reciprocate. The reciprocating baffle 19 and the movable blade support 4 may be two separate parts, which are assembled and fixed by screws or fasteners, or may be an integrated part formed integrally by injection molding.

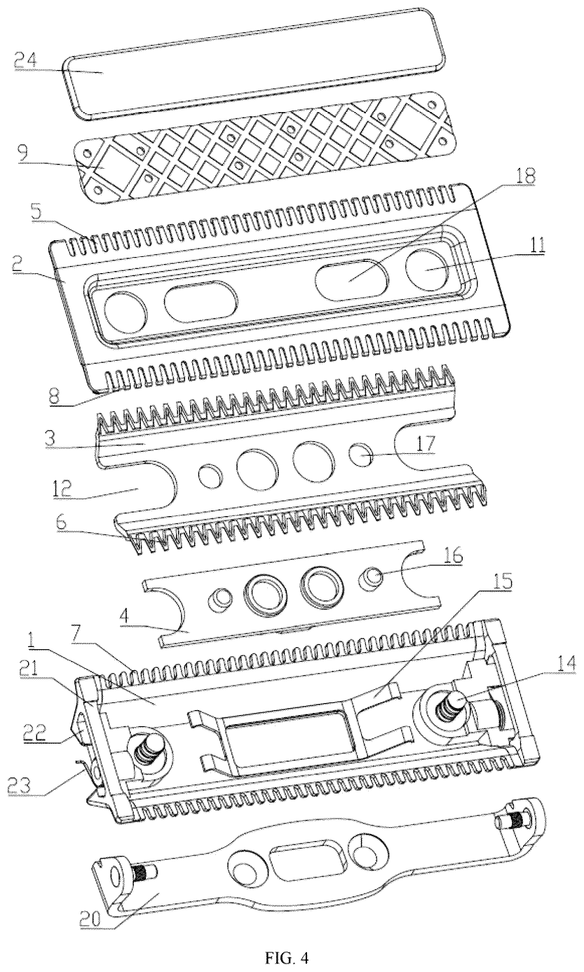

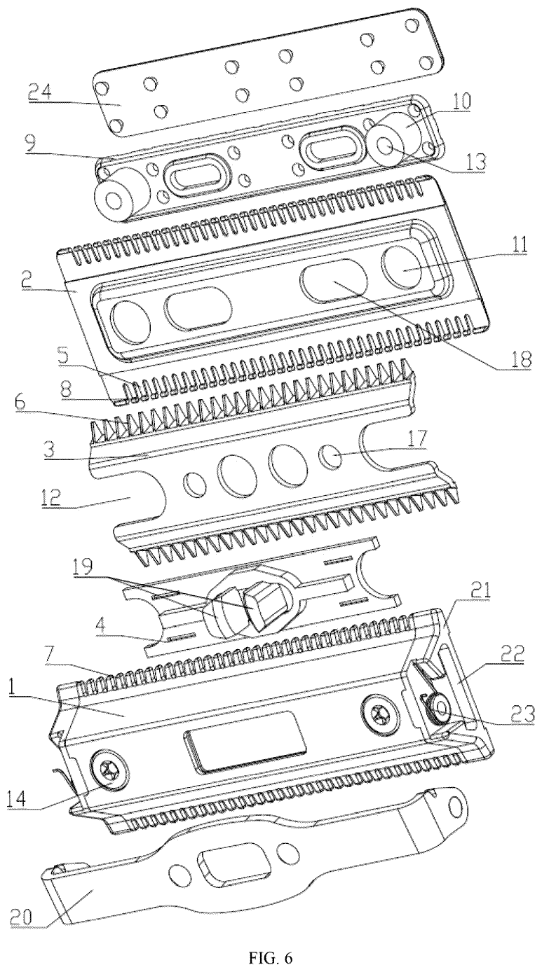

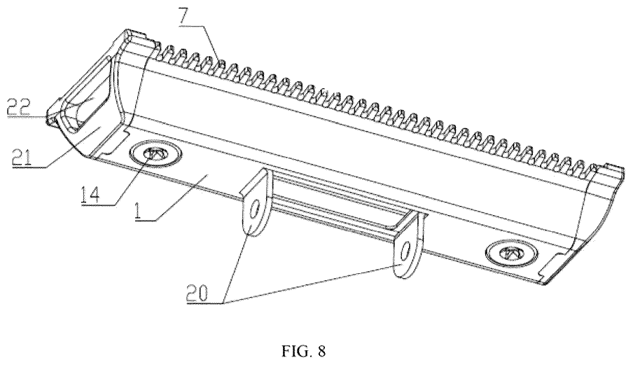

In addition, end covers 21 are arranged at two ends of the bottom shell 1, the end cover 21 is provided with a cleaning port 22 communicated with an inner cavity of the bottom shell 1, and a connecting frame 20 for connecting the main body of the shaver is arranged below the bottom shell 1. After shaving, the shaving tool bit may be put in water for cleaning, so that hair debris inside the tool bit can be easily washed out from the cleaning port 22. The connecting frame 20 may be set as a separate part to be rotatably connected with the bottom shell 1, and then the shaving tool bit is mounted on the main body of the shaver through the connecting frame 20, as shown in FIG. 4 or FIG. 6, and the connecting frame 20 may also be set as an integrated part with the bottom shell 1 to be directly rotatably connected with a shell of the main body of the shaver, as shown in FIG. 8.

In addition, two ends of the connecting frame 20 are rotatably hinged on outer walls of the end covers 21, and the outer wall of the end cover 21 is provided with a torsion spring 23 for resetting an inclination angle of the shaving tool bit. The shaving tool bit may be rotatably connected with the main body of the shaver through the connecting frame 20, so as to realize the function of adjusting a shaving angle of the shaving tool bit in multiple directions.

Specifically, the fixing pressing plate 9 and the limiting column 10 are the integrated part formed integrally by injection molding, which is convenient for production and assembly. In addition, a face cover 24 for enhancing skin feeling is attached to an upper surface of the fixing pressing plate 9. The face cover 24 is generally made of soft silica gel, so that the face cover 24 is easy to contact with the skin during shaving, the soft face cover 24 can improve the skin feeling and use experience of the shaving tool bit, and the appearance of the shaving tool bit is more exquisite at the same time.

Specifically, a height from an upper surface of the fixed blade 2 to a bottom face of the bottom shell 1 is not more than 5 mm, that is, a total thickness of the shaving tool bit is not more than 5 mm, which makes the appearance of the shaving tool bit more exquisite.

The embodiments described in the present invention are only descriptions of the preferred embodiments of the present invention, and are not limited to the precise structures described above and shown in the drawings, and various modifications and improvements may be made without departing from the scope. Various modifications and improvements made by engineering technicians in the art to the technical solution of the present invention without departing from the design concept of the present invention should all fall within the scope of protection of the present invention.

We claim:

1. A shaving tool bit adopting a penetrating-type fixing structure, comprising a bottom shell (1), a fixed blade (2) and a movable blade (3), wherein a movable blade support (4) for mounting the movable blade (3) is arranged in the bottom shell (1) in a reciprocating mode, a fixing pressing plate (9) is arranged above the fixed blade (2), limiting columns (10) penetrating through the fixed blade (2) and the movable blade (3) and extending towards the bottom shell (1) are arranged at two ends of a bottom face of the fixing pressing plate (9), the fixed blade (2) is provided with a through hole (11) for the limiting column (10) to penetrate through, limiting bayonets (12) used for clamping the limiting columns (10) to provide a reciprocating motion space for the movable blade (3) are arranged at two ends of the movable blade (3), and a plurality of protection teeth (7) with tail ends exceeding an outer edge of the movable blade (3) are arranged on two sides of the bottom shell (1) and located below the movable blade (3).

2. The shaving tool bit adopting the penetrating-type fixing structure according to claim 1, wherein two sides of the fixed blade (2) and the movable blade (3) are respectively provided with a plurality of fixed blade teeth (5) and movable blade teeth (6) extending outwards, top faces of the movable blade teeth (6) are attached to bottom faces of the fixed blade teeth (5), and a gap is left between the protection teeth (7) and the movable blade teeth (6).

3. The shaving tool bit adopting the penetrating-type fixing structure according to claim 2, wherein outer edges of the protection teeth (7) outwardly exceed outer edges of the movable blade teeth (6) and do not exceed outermost ends of the fixed blade teeth (5), a number and a layout of the protection teeth (7) correspond to those of the fixed blade teeth (5), and protection heads (8) having a smooth surface and bent towards the movable blade (3) are arranged at tail ends of the fixed blade teeth (5).

4. The shaving tool bit adopting the penetrating-type fixing structure according to claim 1, wherein a screw hole (13) is arranged in the limiting column (10), and a screw (14) penetrating through the bottom shell (1) and screwed into the screw hole (13) is arranged below the bottom shell (1).

5. The shaving tool bit adopting the penetrating-type fixing structure according to claim 1, wherein positioning mounting columns (16) extending towards the fixed blade (2) are arranged at two ends of a top face of the movable blade support (4), a positioning mounting hole (17) for nesting the positioning mounting column (16) is correspondingly arranged in the movable blade (3), and a limiting sliding groove (18) corresponding to the positioning mounting column (16) is arranged on the fixed blade (2).

6. The shaving tool bit adopting the penetrating-type fixing structure according to claim 2, wherein an elastic sheet (15) for abutting against a bottom face of the movable blade support (4) to attach the movable blade teeth (6) to the fixed blade teeth (5) is arranged in the bottom shell (1), and the bottom face of the movable blade support (4) is provided with a reciprocating baffle (19) for cooperating with a main body of a shaver to drive the movable blade support (4) to reciprocate.

7. The shaving tool bit adopting the penetrating-type fixing structure according to claim 1, wherein end covers (21) are arranged at two ends of the bottom shell (1), the end cover (21) is provided with a cleaning port (22) communicated with an inner cavity of the bottom shell (1), and a connecting frame (20) for connecting the main body of the shaver is arranged below the bottom shell (1).

8. The shaving tool bit adopting the penetrating-type fixing structure according to claim 7, wherein two ends of the connecting frame (20) are rotatably hinged on outer walls of the end covers (21), and the outer wall of the end cover (21) is provided with a torsion spring (23) for resetting an inclination angle of the shaving tool bit.

9. The shaving tool bit adopting the penetrating-type fixing structure according to claim 1, wherein the fixing pressing plate (9) and the limiting column (10) are an integrated part formed integrally by injection molding, and a face cover (24) for enhancing skin feeling is attached to an upper surface of the fixing pressing plate (9).

10. The shaving tool bit adopting the penetrating-type fixing structure according to claim 1, wherein a height from an upper surface of the fixed blade (2) to a bottom face of the bottom shell (1) is not more than 5 mm.
